(19) United States
(12) Patent Application Publication
(10) Pub. No.: US 2026/0001813 A1
(43) Pub. Date: Jan. 1, 2026

(54) COMPOSITION FOR MAKING CERAMIC OBJECT AND METHOD OF USING

(71) Applicant: SAINT-GOBAIN CERAMICS & PLASTICS, INC., Worcester, MA (US)

(72) Inventors: Chuanping LI, Shrewsbury, MA (US); Darren ROGERS, Worcester, MA (US); Pierre PISSON, Worcester, MA (US); Isabelle JONES, Somerville, MA (US); Mostafa CHEHADEH, Boylston, MA (US)

(21) Appl. No.: 19/251,166

(22) Filed: Jun. 26, 2025

Related U.S. Application Data
(60) Provisional application No. 63/664,528, filed on Jun. 26, 2024.

(51) Int. Cl. C04B 35/117; C04B 35/634

(52) U.S. Cl. CPC C04B 35/117; C04B 35/6342; C04B 35/63424; C04B 35/6346; C04B 35/63488; C04B 2235/3206; C04B 2235/3217; C04B 2235/3225; C04B 2235/5436

(57) ABSTRACT

A composition may include a ceramic material and a binder system. The ceramic material may be in a content of greater than 50 vol % of the composition. The binder system may include a first water soluble organic material and a second organic material having a melting temperature below 100° C.

### CROSS-REFERENCE TO RELATED APPLICATION(S)

This application claims priority under 35 U.S.C. § 119(e) to U.S. Provisional Patent Application No. 63/664,528, filed on Jun. 26, 2024, entitled “COMPOSITION FOR MAKING CERAMIC OBJECT AND METHOD OF USING,” by Chuanping LI et al., which is assigned to the current assignee hereof and is incorporated herein by reference in its entirety.

### BACKGROUND

### Field of the Disclosure

The present application relates in general to a composition for making ceramic objects and a method of using the composition, and in particular, to a composition including a ceramic material and a binder system and a method of using the composition to make ceramic objects.

### Description of the Related Art

Ceramic objects may be made using injection molding, extrusion, or other techniques. Binders are often used in compositions for making ceramic objects. Removal of binders may be performed by using thermal pyrolysis prior to formation of finally-formed ceramic objects. Energy consumption and the amount of carbon emission caused by binder removal may not be environmentally friendly. Further, distortion and/or cracking of green bodies of ceramic objects often occurs during thermal pyrolysis of binders. The industry continues to demand improved compositions and processes to form ceramic objects.

### BRIEF DESCRIPTION OF THE DRAWINGS

Embodiments are illustrated by way of example and are not limited in the accompanying figures.

FIG. 1 includes a flow chart illustrating a process for forming a ceramic object using a composition according to an embodiment.

FIGS. 2A to 2E include images of exemplary ceramic objects having complex shapes.

FIG. 3 includes a plot illustrating shear rates vs. viscosity of compositions heated at different temperatures according to embodiments herein.

FIG. 4 includes a graph illustrating flexure stress at break of ceramic parts made using compositions according to embodiments.

FIG. 5 includes a scanning electron microscope image of the microstructure of a ceramic object made using a composition according to an embodiment.

FIG. 6 includes a plot of Torque Values of feedstock samples over time.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting.

The following is directed towards a composition including a ceramic material and a binder system and methods of using the composition. In an embodiment, the composition may have improved solid loading and flowability and may be formed into any desired shapes using known techniques for forming shaped ceramic objects. In a further embodiment, the composition may have improved viscosity to facilitate shaping of the composition at a relatively low temperature and/or at a relatively low pressure. In a further embodiment, the composition may facilitate improved removal of binders and improved formation of ceramic objects by having a particular binder system that may help minimize distortion, slumping, crack formation, or formation of any other defects of shaped green bodies of ceramic objects during removal of binders. As used herein, a green body is intended to refer to a body that may be further processed (e.g., heated) to form a finally formed ceramic object.

The composition described in embodiments herein may be suitable for making ceramic objects using techniques including, but not limited to, injection molding, thermoplastic extrusion, 3D printing, or the like, or any combination thereof. In a particular example, the composition may be molded or otherwise shaped at a relatively low temperature and/or at a relatively low pressure. In an exemplary application, the composition may be used to make ceramic objects having desired shapes, such as ceramic cores for use in investment casting of aerospace turbine components, catalyst supports, filters, igniters, and guides, bushings, or the like. In a particular application, the composition may allow molding of ceramic parts, such as ceramic cores at a lower temperature, such as no greater than 100° C., and/or at a lower pressure, such as no greater than 7 bar.

In an embodiment, the composition may include a binder system including a first binder material and a second binder material. The first binder material may include a first organic material. An exemplary first organic material may include a thermoplastic. The second binder material may include a second organic material, such as a thermoplastic that is different from the first organic material. In an embodiment, the composition may include a particular content of the binder system that may facilitate improved property of the composition and improved formation of a ceramic part using the composition. In an example, the composition may include at least 9 vol % of the binder system for the total volume of the composition, such as at least 11 vol %, at least 15 vol %, at least 18 vol %, at least 20 vol %, at least 23 vol %, at least 25 vol %, at least 28 vol %, at least 31 vol %, at least 34 vol %, or at least 38 vol % of the composition. In another example, the content of the binder system may be at most 49 vol % of the composition, at most 45 vol %, at most 40 vol %, at most 35 vol %, at most 33 vol %, at most 30 vol %, at most 28 vol %, or at most 25 vol % of the composition. Moreover, the content of the binder system may be in a range including any of the minimum and maximum percentages noted herein.

In an embodiment, the composition may include a particular melt flow index that may facilitate improved properties of the composition and/or improved formation of a ceramic part using the composition. In an example, the composition may include a melt flow index of at most 80 g/10 min, at most 75 g/10 min, at most 70 g/10 min, at most 60 g/10 min, at most 55 g/10 min, at most 50 g/10 min, at most 46 g/10 min, at most 42 g/10 min, at most 37 g/10 min, at most 33 g/10 min, at most 30 g/10 min, or at most 26 g/10 min. In a further example, the composition may include a melt flow index of at least 1 g/10 min, at least 2 g/10 min, at least 5 g/10 min, at least 8 g/10 min, at least 9 g/10 min, at least 10 g/10 min, at least 11 g/10 min, at least 13 g/10 min, at least 15 g/10 min, at least 18 g/10 min, at least 21 g/10 min, at least 24 g/10 min, at least 26 g/10 min, at least 28 g/10 min, at least 30 g/10 min, at least 33 g/10 min, or at least 38 g/10 min. Moreover, the composition may have a melt flow index in a range including any of the minimum and maximum values noted herein. For example, the melt flow rate of the composition may be in a range including at least 1 g/10 min and at most 80 g/10 min or in a range including at least 3 g/10 min and at most 55 g/10 min or in a range including at least 5 g/10 min and at most 46 g/10 min.

In an embodiment, the binder system may include a particular melt flow index that may facilitate improved properties of the composition and/or improved formation of a ceramic part using the composition. In an example, the binder system may include a melt flow index of at most 700 g/10 min, at most 500 g/10 min, at most 400 g/10 min, at most 300 g/10 min, at most 200 g/10 min, at most 100 g/10 min, at most 70 g/10 min, at most 60 g/10 min, at most 55 g/10 min, at most 50 g/10 min, at most 45 g/10 min, at most 40 g/10 min, at most 35 g/10 min, at most 30 g/10 min, at most 25 g/10 min, at most 20 g/10 min, at most 16 g/10 min, at most 13 g/10 min, or at most 11 g/10 min. In a further example, the binder system may include a melt flow index of at least 5 g/10 min, at least 10 g/10 min, at least 15 g/10 min, at least 20 g/10 min, at least 30 g/10 min, at least 40 g/10 min, at least 50 g/10 min, at least 60 g/10 min, at least 70 g/10 min, at least 80 g/10 min, or at least 90 g/10 min. Moreover, the binder system may have a melt flow index in a range including any of the minimum and maximum values noted herein. As used herein, the melt flow rate of a material may be measured at 90° C. according to ASTM D1238 or ISO 1133. Accordingly, the MFI of the binder system can be determined using a sample of the binder system following ASTM D1238 or ISO 1133.

In an embodiment, the binder system may include a particular content of the second binder material that may facilitate improved property and/or improved processability of the composition and/or improved formation of a ceramic part using the composition. In an example, the binder system may include at least 5 wt % of the second binder material for a total weight of the binder system, at least 8 wt %, at least 10 wt %, at least 12 wt %, at least 13 wt %, at least 15 wt %, at least 17 wt %, at least 19 wt %, at least 21 wt %, at least 23 wt %, at least 25 wt %, at least 27 wt %, at least 29 wt %, at least 30 wt %, or at least 31 wt % of the total weight of the binder composition. In another example, the binder system may include less than 50 wt % of the second binder material for the total weight of the binder composition, such as at most 45 wt %, at most 42 wt %, at most 40 wt %, at most 38 wt %, at most 36 wt %, at most 34 wt %, at most 32 wt %, at most 31 wt %, at most 28 wt %, at most 25 wt %, at most 22 wt %, at most 20 wt %, at most 18 wt %, or at most 16 wt % of the total weight of the binder composition. Moreover, the binder system may include a content of the second binder material in a range including any of the minimum and maximum percentages noted herein. For example, the binder system may include a content of the second binder in a range including at least 5 wt % and at most 45 wt % or in a range including at least 12 wt % and at most 38 wt % or in a range including at least 21 wt % and at most 34 wt %.

In an embodiment, the second binder material may include a particular melting temperature that may facilitate improved properties of the composition and/or improved formation of a ceramic part using the composition. In an example, the melting temperature of the second binder material may be less than 100° C., such as at most 97° C., at most 95° C., at most 92° C., at most 90° C., at most 87° C., at most 85° C., at most 83° C., at most 81° C., at most 78° C., at most 75° C., at most 72° C., at most 69° C., at most 66° C., at most 64° C., at most 62° C., or at most 60° C. In another example, the melting temperature of the second binder material may be at least 40° C., at least 44° C., at least 47° C., at least 50° C., at least 53° C., at least 55° C., at least 58° C., at least 60° C., at least 62° C., at least 64° C., at least 67° C., at least 70° C., at least 72° C., or at least 75° C. Moreover, the melting temperature of the second binder material may be in a range including any of the minimum and maximum values noted herein.

In a further embodiment, the second binder material may include a particular melt flow index that may facilitate improved properties of the composition and/or improved formation of a ceramic part using the composition. In this disclosure, melt flow index is also referred to as melt flow rate. In an example, the second binder material may include a melt flow index of at most 22 g/10 min, at most 20 g/10 min, at most 18 g/10 min, at most 17 g/10 min, at most 16 g/10 min, at most 15 g/10 min, at most 14 g/10 min, at most 13 g/10 min, at most 12 g/10 min, or at most 11 g/10 min. In a further example, the second organic material may include a melt flow index of at least 3 g/10 min, at least 5 g/10 min, at least 6 g/10 min, at least 7 g/10 min, at least 8 g/10 min, at least 9 g/10 min, at least 10 g/10 min, or at least 11 g/10 min. Moreover, the second binder material may have a melt flow index in a range including any of the minimum and maximum values noted herein.

In a further embodiment, the second binder material may include a particular viscosity that may facilitate improved properties of the composition and/or improved formation of a ceramic part using the composition. In an example, the second binder material may include a viscosity of at most 500 Pas at a shear rate of 100 [l/s] and at a temperature from 70° C. to 80° C. In another example, the second organic material may include a viscosity of at most 5000 Pa·s at a shear rate of 0.1 [l/s] and at a temperature from 70° C. to 80° C.

In an embodiment, the second binder material may include a polymer. A particular example may include ethylene-vinyl acetate copolymer (EVA), polycaprolactone, ethylene butyl acrylate copolymer (EBA), polyhydroxyalkanoates (PHA), or any combination thereof. In a further embodiment, the second binder material may include polycaprolactone having a particular molecular weight that may facilitate improved property and/or improved formation of a ceramic part using the composition. In an example, the second binder material may include polycaprolactone having approximate molecular weight of at least 25000 and less than 80000, such as at least 25000 and at most 50000. The approximate molecular weight may be determined by using Gel Permeation Chromatograph and using Tetrahydrofuran (THF) as solvent at 25° C.

In an embodiment, the binder system may include a particular content of the first binder material that may facilitate improved property and/or improved processability of the composition and/or improved formation of a ceramic part using the composition. In an example, the binder composition may include greater than 50 wt % of the first binder material for the total weight of the binder system, such as at least 54 wt %, at least 58 wt %, at least 61 wt %, at least 64 wt %, at least 67 wt %, at least 70 wt %, at least 72 wt %, or at least 74 wt % of the first binder material for the total weight of the binder system. In another example, the binder system may include at most 91 wt % of the first binder material for the total weight of the binder system, such as at most 88 wt %, at most 85 wt %, at most 82 wt %, at most 80 wt %, at most 77 wt %, at most 75 wt %, at most 73 wt %, or at most 70 wt % of the first binder material for the total weight of the binder composition. Moreover, the binder system may include a content of the first binder material in a range including any of the minimum and maximum percentages noted herein.

In an embodiment, the first binder material may include a particular compatibility with the second binder material that may facilitate improved property and/or improved formation of a ceramic part using the composition. In an embodiment, the first binder material may be compatible with the second binder material such that a mixture of the first and second binder materials may be homogenous. In a further embodiment, the mixture of the first and second binder materials may be essentially free of a separated phase having a maximum dimension of greater than 100 microns. In a particular embodiment, the mixture of the first and second binder materials may be devoid of phase separation.

In a particular embodiment, the first binder material may be soluble in a certain solvent that may facilitate improved property and/or improved formation of a ceramic part using the composition. In a particular embodiment, the second binder material may have minimized solubility or may be insoluble for the solvent that the first binder material may dissolve in. For example, the second binder material may have a solubility of less than 5% at 20° C. to 25° C. for a solvent of the first binder material.

In an embodiment, the first binder material may be hydrophilic. For example, the first binder material may include a particular hydrophilicity that may facilitate improved property and/or improved formation of a ceramic part using the composition.

In a particular embodiment, the first binder material may have a particular solubility in water. For example, the first binder material may have a solubility in water at 20° C. to 25° C. of at least 30%, at least 40%, at least 50%, at least 60%, at least 70%, at least 75%, at least 80%, at least 85%, at least 90%, or at least 95%. In another example, the solubility of the first organic material in water at 20° C. to 25° C. may be 100%. In certain instances, the first binder material may have a solubility in water of at most 98% at 20° C. to 25° C., at most 90%, at most 80%, at most 70%, at most 60%, or at most 50% at 20° C. to 25° C. Moreover, the first binder may have a water solubility in a range including any of the minimum and maximum percentages noted herein. In a particular example, the first binder material may have a solubility in water of up to 100% and at least 75%. In another particular embodiment, the second binder is water insoluble. Solubility can be measured as follows. A green body formed using the composition may be weighed and then immersed in water for 12 hours at 20° C. to 25° C. Then the green body may be dried and weighed to obtain the weight loss of the green body before and after water treatment. The weight loss can be determined by the formula, C_{L}=[(W_{O}−W_{A})/W_{O}]×100%, wherein C_{L} may represent the weight percent of the weight loss, W_{O} may represent the original weight of the green body prior to the water treatment, and W_{A} may represent the weight of the dried green body after the water treatment. Solubility of the first binder material can be determined by the formula, S_{b1}=(C_{L}/C_{b1})×100%, wherein S_{b1} may represent solubility of the first binder, C_{b1} may represents the weight content of the first binder material for the total weight of the composition or the green body prior to the water treatment.

In an embodiment, the first binder material may be solid. In another embodiment, the first binder material may include a particular melting temperature that may facilitate improved properties of the composition and/or improved formation of a ceramic part using the composition. In an example, the melting temperature of the first binder material may be below 100° C., such as at most 92° C., at most 85° C., at most 73° C., at most 60° C., at most 55° C., at most 50° C., at most 47° C., at most 44° C., at most 40° C., or at most 38° C. In another example, the first binder material may include a melting temperature of at least 27° C., at least 30° C., at least 33° C., at least 35° C., at least 37° C., at least 40° C., at least 44° C., at least 48° C., at least 52° C., or at least 55° C. Moreover, the melting temperature of the first binder material may be in a range including any of the minimum and maximum values noted herein.

In an embodiment, the first binder material may include a particular Hydroxyl Value that may facilitate improved properties of the composition and/or improved formation of a ceramic part using the composition. In an example, the Hydroxyl Value of the first binder material may be at least 35, at least 50, at least 60, at least 80, at least 100, at least 105, at least 115, at least 120, or at least 125. In another example, the first binder material may have a Hydroxyl Value of at most 295, at most 275, at most 260, at most 240, at most 220, at most 200, at most 170, at most 160, at most 130, or at most 120. Moreover, the Hydroxyl Value of the first binder material may be in a range including any of the minimum and maximum values noted herein. Hydroxyl value can be determined using the titration method according to ASTM E1899 and EN ISO4629-2.

In an embodiment, the first binder material may include a particular melt flow index that may facilitate improved properties of the composition and/or improved formation of a ceramic part using the composition. In an example, the first binder material may include a melt flow rate of at least 10 g/10 min, at least 30 g/10 min, at least 50 g/10 min, at least 80 g/10 min, at least 100 g/10 min, at least 130 g/10 min, at least 150 g/10 min, at least 180 g/10 min, at least 200 g/10 min, or at least 300 g/10 min. In another example, the melt flow rate of the first binder material may be at most 1000 g/10 min, at most 800 g/10 min, at most 600 g/10 min, at most 500 g/10 min, at most 400 g/10 min, at most 300 g/10 min, at most 200 g/10 min, at most 100 g/10 min, or at most 50 g/10 min. Moreover, the melt flow rate of the first binder material may be in a range including any of the minimum and maximum values noted herein.

In another embodiment, the first binder material may include a particular thermoplasticity that may facilitate improved property and/or improved formation of a ceramic object using the composition.

In an embodiment, the first binder material may include polyethylene glycol, such as PEG-1000, PEG-1400, PEG-2000, PEG-8000, PEG-10000, or any combination thereof.

In a particular embodiment, the first binder material may include polyethylene glycol having a particular molecular weight that may facilitate improved properties of the composition and/or improved formation of a ceramic part using the composition. In an example, the first binder material may include polyethylene glycol having a molecular weight of greater than 800 g/mol, or at least 1000 g/mol. Alternatively or additionally, the molecular weight of polyethylene glycol may be at most 12000 g/mol, at most 10000 g/mol, at most 8000 g/mol, at most 6000 g/mol, at most 4000 g/mol, at most 3350 g/mol, at most 2000 g/mol, or at most 1000 g/mol. In a further example, the first binder material may include one or more polyethylene glycol having a molecular weight in a range including any of the minimum and maximum values noted herein, such as in a range including at least 800 g/mol and at most 10000 g/mol or in a range including at least 1000 g/mol and at most 8000 g/mol.

The composition of embodiments herein may include an improved solid loading of a ceramic material compared to a conventional composition having the same ceramic material but a different binder material. In an embodiment, the composition may include greater than 50 vol % of a ceramic material for the total volume of the composition, such as at least 55 vol %, at least 58 vol %, at least 60 vol %, at least 62 vol %, at least 63 vol %, at least 65 vol %, at least 60 vol %, at least 62 vol %, at least 63 vol %, at least 66 vol %, at least 67 vol %, or at least 75 vol % of the ceramic material for the total volume of the composition. Alternatively or additionally, the content of the ceramic material is at most 85 vol % for the total volume of the composition, at most 82 vol %, at most 80 vol %, at most 78 vol %, at most 76 vol %, at most 75 vol %, at most 72 vol %, at most 70 vol %, at most 68 vol %, at most 66 vol %, at most 65 vol %, at most 62 vol %, or at most 60 vol % for the total volume of the composition. Moreover, the content of the ceramic material in the composition may be in a range including any of the minimum and maximum percentages noted herein. In an example, the composition may include greater than 50 vol % of the ceramic material or in a range of at least 58 vol % and at most 82 vol % or in a range of at least 60 vol % and at most 75 vol % or in a range of at least 60 vol % and at most 68 vol % for the total volume of the composition.

In an embodiment, the ceramic material may include a carbide, a nitride, diamond, or a combination thereof. In a particular embodiment, the ceramic material may include an oxide. An exemplary oxide may include one or more of metal oxides including aluminum oxide; chromium oxide; silicon oxide; one or more of alkaline earth metal oxide including magnesium oxide, calcium oxide, barium oxide, or any combination thereof; one or more of alkali metal oxide; a rare earth oxide including yttrium oxide, zirconium oxide, or any combination thereof; or any combination thereof.

In an embodiment, the ceramic material may include a primary component. The primary component may be in a content of greater than 50 wt % for the total weight of the ceramic material. In an example, the primary component may include an oxide, such as an alkaline earth metal oxide, an alkali metal oxide, a rare earth oxide, a transition metal oxide, or a combination thereof. In another example, the primary component may include aluminum oxide, silicon carbide, zirconium oxide, zircon, chromium oxide, lithium oxide, magnesium oxide, strontium oxide, or a combination thereof. In a particular example, the primary component may include aluminum oxide. In a further embodiment, the ceramic material may include a particular content of the primary component that may facilitate improved formation and/or properties of the ceramic core using the composition. In an example, the content of the primary component may be at least 75 wt % of the ceramic material, at least 77 wt %, at least 79 wt %, at least 81 wt %, at least 83 wt %, at least 85 wt %, at least 87 wt %, at least 89 wt %, at least 92 wt %, or at least 95 wt % for the total weight of the ceramic material. In another example; the content of the primary component may be at most 98 wt % of the ceramic material, at most 95 wt %, at most 93 wt %, at most 91 wt %, at most 89 wt %, or at most 87 wt % of the ceramic material. Moreover, the content of the primary component may be in a range including any of the minimum and maximum percentages noted herein.

In a further embodiment, the primary component of the ceramic material may include particular particle sizes that may facilitate improved formation of a ceramic part using the composition. In an embodiment, the primary component may include coarse particles, fine particles, or a combination thereof. For example, the primary component may include a maximum particle size of at least 200 microns, at least 300 microns, or at least 500 microns. In another example, the maximum particle size may be at most 5 mm, at most 2 mm, at most 1 mm, at most 800 microns, at most 600 microns, or at most 400 microns. Moreover, the primary component may include a maximum particle size in a range including any of the minimum and maximum values noted herein. In a further embodiment, the primary component may include a minimum particle size of at least 0.1 microns, such as at least 0.5 microns, at least 1 micron, at least 2 microns, at least 3 microns, at least 5 microns, at least 7 microns, at least 10 microns, or at least 20 microns. Additionally or alternatively, the minimum particle size may be at most 80 microns, at most 70 microns, at most 62 microns, at most 55 microns, at most 40 microns, at most 30 microns, at most 20 microns, or at most 10 microns. Moreover, the primary component may include a minimum particle size in a range including any of the minimum and maximum values noted herein.

In a further embodiment, the primary component may include first particles having a first median particle size that may facilitate improved formation of a ceramic part using the composition. In an example, the first median particle size may be greater than 12 microns, such as at least 15 microns, at least 18 microns, at least 20 microns, at least 25 microns, at least 28 microns, at least 31 microns, at least 35 microns, at least 37 microns, at least 40 microns, at least 43 microns, or at least 45 microns. Alternatively or additionally, the primary component may include first particles having a first median particle size of at most 300 microns, at most 250 microns, at most 210 microns, at most 180 microns, at most 160 microns, at most 130 microns, at most 10 microns, at most 90 microns, at most 72 microns, at most 66 microns, at most 62 microns, at most 58 microns, at most 55 microns, at most 52 microns, at most 50 microns, or at most 48 microns. Moreover, the first median particle size may be in a range including any of the minimum and maximum percentages noted herein. For example, the first median particle size may be in a range of greater than 12 microns and at most 72 microns, or in a range of at least 20 microns and at most 60 microns, or in a range of at least 30 microns and at most 55 microns, or in a range of at least 40 microns and at most 50 microns.

In an embodiment, the primary component of the ceramic material may include a particular content of the first particles that may facilitate improved formation of a ceramic part using the composition. In an example, the first particles may be in a content of at least 35 wt % for the weight of the primary component, such as at least 40 wt %, at least 43 wt %, at least 46 wt %, at least 48 wt %, at least 50 wt %, or at least 52 wt % for the weight of the primary component. Alternatively or additionally, the content of the first particles may be 75 wt % for the weight of the primary component, such as at most 71 wt %, at most 67 wt %, at most 64 wt %, at most 60 wt %, at most 58 wt %, or at most 55 wt % for the weight of the primary component. Moreover, the content of the first particles may be in a range including any of the minimum and maximum percentages noted herein. For example, the content of the first particles may be in a range of at least 35 wt % and at most 75 wt % of the primary component, or in a range of at least 40 wt % and at most 60 wt %, or in a range of at least 45 wt % and at most 55 wt % of the primary component.

In an embodiment, the primary component may include second particles having a second median particle size that may facilitate improved formation of a ceramic part using the composition. In an example, the second median particle size may be at least 2 microns, such as at least 3 microns, at least 4 microns, at least 5 microns, at least 6 microns, or at least 7 microns. Alternatively or additionally, the second particles may include a second median particle size of at most 12 microns, at most 10 microns, at most 9 microns, at most 8 microns, or at most 7 microns. Moreover, the second median particle size may be in a range including any of the minimum and maximum percentages noted herein. For example, the second median particle size may be in a range of at least 2 microns and at most 12 microns, in a range of at least 4 microns and at most 10 microns, or in a range of at least 6 microns and at most 8 microns.

In an embodiment, the primary component of the ceramic material may include a particular content of the second particles that may facilitate improved formation of a ceramic part using the composition. In an example, the second particles may be in a content of at least 5 wt % for the weight of the primary component, such as at least 8 wt %, at least 10 wt %, at least 12 wt %, at least 15 wt %, at least 18 wt %, at least 20 wt %, at least 22 wt %, at least 25 wt %, or at least 27 wt % for the weight of the primary component. Alternatively or additionally, the content of the second particles may be at most 46 wt % for the weight of the primary component, at most 44 wt %, at most 42 wt %, at most 40 wt %, at most 37 wt %, at most 35 wt %, at most 32 wt %, at most 30 wt %, or at most 28 wt % for the weight of the primary component. Moreover, the content of the second particles may be in a range including any of the minimum and maximum percentages noted herein. For example, the content of the second particles may be in a range including at least 5 wt % and at most 46 wt % of the primary component, in a range including at least 12 wt % and at most 42 wt %, or in a range including at least 22 wt % and at most 32 wt % of the primary component.

In an embodiment, the primary component may include third particles having a third median particle size that may facilitate improved formation of a ceramic part using the composition. In an example, the third median particle size may be at least 0.1 microns, at least 0.15 microns, at least 0.17 microns, at least 0.2 microns, or at least 0.3 microns. In another example, the third median particle size may be less than 2 microns, such as at most 1.7 microns, at most 1.4 microns, at most 1.2 microns, at most 1 micron, at most 0.7 microns, at most 0.5 microns, at most 0.4 microns, or at most 0.3 microns. Moreover, the third median particle size may be in a range including any of the minimum and maximum percentages noted herein. For example, the third median particle size may be in a range of at least 0.1 microns and less than 2 microns, in a range of at least 0.15 microns and at most 1.2 microns, or in a range of at least 0.2 microns and at most 0.7 microns.

In an embodiment, the primary component of the ceramic material may include a particular content of the third particles that may facilitate improved formation of a ceramic part using the composition. In an example, the content of the third particles may be at least 3 wt % for the weight of the primary component, such as at least 5 wt %, at least 8 wt %, at least 10 wt %, at least 12 wt %, at least 15 wt %, at least 18 wt %, or at least 21 wt % for the weight of the primary component. In another example, the content of the third particles may be at most 44 wt % for the weight of the primary component, at most 41 wt %, at most 38 wt %, at most 35 wt %, at most 32 wt %, at most 30 wt %, at most 28 wt %, at most 25 wt %, at most 23 wt %, or at most 20 wt % for the weight of the primary component. Moreover, the content of the third particles may be in a range including any of the minimum and maximum percentages noted herein. For example, the content of the third particles may be in a range of at least 3 wt % and at most 44 wt % of the primary component, in a range of at least 8 wt % and at most 38 wt %, or in a range of at least 15 wt % and at most 28 wt % of the primary component.

In another embodiment, the ceramic material may include a secondary component, such as a sintering aid, a thickener, or another that may help modify flowability of the composition, packing density of a green body, and/or sintering process to form a finally formed body, and/or properties of sintered bodies, or any combination thereof. The secondary component may be in a content less than the content of the primary component, such as less than 50 wt %, at most 35 wt %, at most 20 wt %, at most 10 wt %, or at most 5 wt % for the weight of the ceramic material. In an embodiment, the secondary component may include an oxide, such as yttrium oxide, magnesium oxide, silica, alumina, or any combination thereof, a nitride, such as boron nitride, a carbide, or the like, or any combination thereof. In a further embodiment, the secondary component may include any particle size noted in embodiments herein with respect to the primary component. In a further embodiment, the secondary component may include a different average, maximum, and/or minimum particle size and/or particle size distribution than the primary component. In an example, the secondary component may include particles having a smaller minimum particle size than the primary component. In another example, the secondary component may include particles having a similar minimum, maximum, and/or average particle size to the primary component. In still another embodiment, the ceramic material may consist essentially of a single material, excluding unavoidable impurity that may come with the material.

In a further embodiment, the composition may include a particular viscosity at a processing temperature that may facilitate improved formation of a ceramic part using the composition. In another embodiment, the composition may include a relatively low viscosity at a relatively high shear rate. In an example, the composition may include a viscosity of at most 500 Pa·s at a shear rate of 100 [l/s] and at a temperature from 70° C. to 80° C., such as at most 300 Pa·s, at most 150 Pa·s, at most 100 Pa·s, at most 50 Pa·s, at most 30 Pas, at most 10 Pa·s, at most 8 Pa·s, at most 5 Pa·s, at most 3 Pa·s, at most 1 Pa·s, at most 0.5 Pa·s, at most 0.3 Pa·s, at most 0.1 Pa·s, at most 0.05 Pa·s, at most 0.03 Pa·s, or at most 0.01 Pa·s at a shear rate of 100 [l/s] and at a temperature from 70° C. to 80° C. In another example, the composition may include a viscosity of at least 0.001 Pa·s at a shear rate of 100 [l/s] and at a temperature from 70° C. to 80° C., such as at least 0.003 Pa·s, at least 0.005 Pa·s, at least 0.008 Pa·s, at least 0.01 Pa·s, at least 0.02 Pa·s, at least 0.05 Pa·s, at least 0.07 Pa·s, at least 0.1 Pa·s, at least 1 Pa·s, at least 5 Pa·s, at least 8 Pa·s, at least 10 Pa·s, at least 20 Pa·s, at least 40 Pa·s, at least 80 Pa·s, at least 100 Pas, or at least 200 Pas at a shear rate of 100 [l/s] and at a temperature from 70° C. to 80° C. Moreover, the composition may include a viscosity in a range including any of the minimum and maximum values noted herein.

In a further embodiment, the composition may include a relatively high viscosity at a relatively low shear rate. In an example, the composition may include a viscosity of at most 20000 Pa·s at a shear rate of 0.1 [l/s] and a temperature from 70° C. to 80° C., such as at most 10000 Pa·s, at most 5000 Pa·s, at most 3000 Pa·s, at most 2000 Pa·s, at most 1500 Pa·s, at most 800 Pa·s, at most 500 Pa·s, at most 200 Pa·s, at most 100 Pa·s, or at most 70 Pa·s at a shear rate of 0.1 [l/s] and at a temperature from 70° C. to 80° C. In another example, the composition may include a viscosity of at least 1 Pa·s at a shear rate of 0.1 [l/s] and at a temperature from 70° C. to 80° C., such as at least 5 Pa·s, at least 8 Pa·s, at least 10 Pa·s, at least 25 Pa·s, at least 30 Pa·s, at least 40 Pa·s, at least 55 Pa·s, at least 80 Pa·s, at least 100 Pa·s, at least 110 Pa·s, at least 300 Pa·s, at least 600 Pa·s, at least 900 Pa·s, at least 1000 Pa·s, at least 1100 Pa·s, at least 3000 Pa·s, or at least 5000 Pa·s at a shear rate of 0.1 [l/s] and at a temperature from 70° C. to 80° C. Moreover, the composition may include a viscosity in a range including any of the minimum and maximum values noted herein.

In an embodiment, the composition may include a particular final Torque Value that may facilitate improved processability of the composition and/or formation of a ceramic part using the composition. In an example, the composition may include a final Torque Value of at most 10 Nm or less than 10 Nm, such as at most 8 Nm, at most 7 Nm, at most 6 Nm, at most 5 Nm, at most 4 Nm, or at most 3.5 Nm. In another example, the composition may include a final Torque Value of at least 0.5 Nm, at least 1 Nm, at least 1.5 Nm, at least 2 Nm, or at least 2.5 Nm. Moreover, the final Torque Value may be in a range including any of the minimum and maximum values noted herein. It is worth noting that the composition having a suitable final Torque Value can facilitate improved formation of parts with complex shapes using injection molding at low molding temperature and pressure. A final Torque Value greater than 10 Nm may cause deformation of molds that are adapted for low-temperature and low-pressure injection molding, particularly for forming complex shapes. The final Torque Value may be determined as described in Examples of this disclosure.

An example of a complex shape may include a body having varying thickness along a length or height of the body, one or more cured portions, sharp angles (e.g., an acute angle), one or more cavities, one or more tortuous channels that may extend through at least a portion of the body, or any combination thereof.

In an embodiment, the composition may optionally include a coupling agent, such as a dispersant and/or a surfactant, emulsifier, a filler material, a lubricant, pore former, or another additive, or any combination thereof. An exemplary pore former may include carbon black or graphite. In another example, pore formers may include organic materials, such as organic powders, with higher melting point (e.g., greater than 100° C.). A particular example may include organic powders having the melting point higher than 100° C. and up to 200° C., including but not limited to, polyethylene powder, polyethylene wax powder, polypropylene powder, polypropylene wax powder, or any combination thereof. An exemplary coupling agent may include glycol stearate, stearate acid, or the like, or any combination thereof. In an embodiment, the composition may include a coupling agent in a content of up to 8 vol % of for the volume of the composition, such as up to 6 vol %, up to 5 vol %, or up to 4 vol %, and/or at least 0.1 vol %, at least 0.5 vol %, at least 1 vol %, at least 2 vol %, or at least 3 vol % for the volume of the composition. In another embodiment, the composition may include up to 3 wt % of a coupling agent for the weight of the composition, such as at most 2.5 wt %, at most 2 wt %, at most 1.5 wt %, or at most 1 wt % of a coupling agent for the weight of the composition. Additionally or alternatively, the composition may include at least 0.1 wt % of a coupling agent for the weight of the composition, such as at least 0.2 wt %, at least 0.5 wt %, at least 0.8 wt %, at least 1 wt %, at least 1.2 wt %, or at least 1.5 wt % of a coupling agent for the weight of the composition. Moreover, the composition may include a content of a coupling agent in a range including any of the minimum and maximum percentages noted herein. For example, the composition may include up to 3 wt % of a coupling agent, up to 2 wt %, up to 1 wt %, or from 0.1 wt % to 1 wt % of a coupling agent for the weight of the composition.

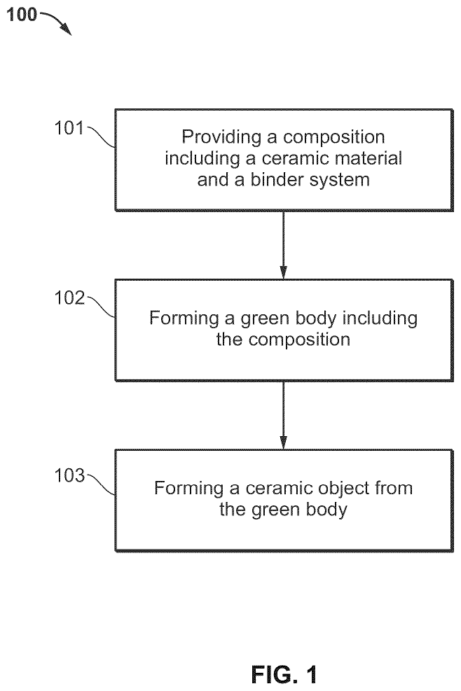

FIG. 1 includes a flowchart illustrating a process 100 of making a ceramic object using the composition of embodiments herein. The process 100 may start at block 101. In an embodiment, the composition may be prepared by forming a uniform mixture including the ceramic material, the binder system, and a coupling agent. Mixing may be facilitated with the aid of a mixing device. In a particular embodiment, mixing may be performed at an elevated temperature. For example, mixing may be performed at a temperature not lower than the melting point of the first binder material and/or the second binder material so that the mixture may be fluid. In a further example, mixing may be performed at a temperature of below 100° C., such as at a temperature of up to 90° C., from 50° C. to 90° C., from 60° C. to 85° C., or from 70° C. to 80° C.

The process 100 may continue to block 102, forming a green body including the composition. In an embodiment, forming the green body may include casting, molding, pressing, extruding, and the like to give the initial mixture shape. In a particular example, the mixture may be injected into a mold having a suitable shape to form the green body. In a particular example, the composition of the embodiments herein may allow the use of a soft or disposable tooling, such as plastics, to form the green body at a relatively low temperature and/or at a relatively low pressure. After reading this disclosure, a skilled artisan appreciates a mold made of another material, such as aluminum or steel may also be used to shape the composition. In another particular example, the mixture may be extruded to form a green body having a desired shape. It is to be appreciated that the green body may have any suitable shape or dimension as desired by applications.

In a further embodiment, forming the green body may be performed at an elevated temperature below 100° C. For example, shaping may be performed at a temperature similar to the melting temperature of the first binder material and/or the second binder material. In another example, shaping the composition may include injection molding and/or extruding at a temperature below 100° C., such as at a temperature of up to 90° C., from 50° C. to 90° C., from 60° C. to 85° C., from 70° C. to 80° C., or up to 75° C.

In an embodiment, forming a green body may be performed at a relatively low pressure.

For example, injection molding may be performed at a pressure that may be less than 7 bar, such as at most 6 bar or at most 5 bar. Additionally or alternatively, injection molding may be performed at a pressure of at least 4 bar, such as at least 5 bar or at least 6 bar. Moreover, injection molding may be performed at a pressure in a range including any of the minimum and maximum values noted herein. In another example, extrusion may be performed. An exemplary torque of the screw may be from 1 Nm to 80 Nm at the temperatures of up to 80° C.

In an embodiment, the process 100 may include removing the first binder material. In a further embodiment, removing the first binder material may include dissolving at least a portion of the first binder material in a solvent. For example, a suitable solvent may be applied to the green body to at least partially remove the first binder material. In a particular example, removing the first binder material may include removing at least a majority of the first binder material, such as at least 60 wt %, at least 70 wt %, at least 80 wt %, or essentially all of the first binder material. The amount of the first binder material removed by the solvent may be determined by measuring the weight loss of the green body and using the formula, R_{1stb}=[(W_{GB}−W_{ST-GB})/C_{1stb}]×100%. R_{1stb} may represent the percentage of the first binder material that is removed by the solvent, W_{GB} may represent the weight of the green body, and W_{ST-GB} may represent the weight of the green body after the solvent treatment, and C_{1stb} may represent the content of the first binder material (wt %) in the composition.

In an embodiment, removing the first binder material may be performed at room temperature, i.e., 20° C. to 25° C. or at a heated condition that may help accelerate removal of the first binder material. For example, removal of the first binder material may be performed at a temperature that may be below any of the melting point of the first and second binder materials. In another embodiment, removing the first binder material may be performed at an ambient condition. In an embodiment, the green body may be treated with a suitable solvent for a period of time to at least partially remove the first binder material. After reading this disclosure, a skilled artisan may appreciate that the time needed to at least partially remove the first binder material may depend on solubility of the first binder material, a dimension of the green body, e.g., width, length, radius, and/or cross-sectional thickness, the temperature used for the solvent treatment, or any combination thereof. In an example, the green body may be treated for up to hours to facilitate removal of the first binder material. In a specific implementation, a green body having a thickness of 2 mm may be made using the composition including 60 vol % to 75 vol % of a ceramic material and a binder system including 70 wt % to 80 wt % of PEG-1000 and 20 wt % to 30 wt % of CAPA 6250, and approximately 70 wt % of PEG-1000 may be removed after the green body is immersed in water for up to 8 hours at 20° C. to 25° C. In another embodiment, removing the first binder material may include forming interconnected porosity in the green body. Particularly, interconnected porosity may be formed simultaneously with removal of the first binder material. In a particular embodiment, the interconnected porosity may serve as gas channels that may facilitate removal of the second binder material, which will be described in detail later in this disclosure.

In a further embodiment, the process may include removing the second binder material. In a particular example, removal of the second binder material may be performed after removal of the first binder material. In a further example, the green body may be heated to a temperature of at least 200° C. to at most 400° C. to facilitate decomposition and removal of the second binder material. In still another example, the green body may be heated for 40 to 80 hours to facilitate removal of the second binder material. After reading this disclosure, a skilled artisan may appreciate that the time and heating temperature needed to remove the second binder material may depend on a dimension of the green body, e.g., width, length, radius, cross-sectional thickness, or any combination thereof. In a particular embodiment, removal of the second binder material may include evaporation of the decomposed second binder material via at least some of gas channels. It is worth noting formation of gas channels via removal of the first binder material may help prevent distortion and/or defects formation of the green body during removal of the second binder materials, which may be facilitated by releasing gases generated by decomposition of the second binder material through the gas channels.

The process 100 may continue to block 103, forming a ceramic object from the green body. After removal of the first and second binder materials, the green body may be heated to form the ceramic object. In an example, heating the green body may be conducted at a temperature in a range from 1200° C. to 1850° C. In a particular example, heating may include a sintering temperature of the ceramic material. In a further example, heating may be performed for at least 5 hours to up to 60 hours. In another example, heating may be performed in an oxidizing atmosphere. In still another example, heating may be performed in an inert condition. After reading this disclosure, a skilled artisan appreciates that heating conditions may depend on the composition of the ceramic material, a dimension of the green body, e.g., width, length, radius, cross-sectional thickness, or any combination thereof, or any combination thereof.

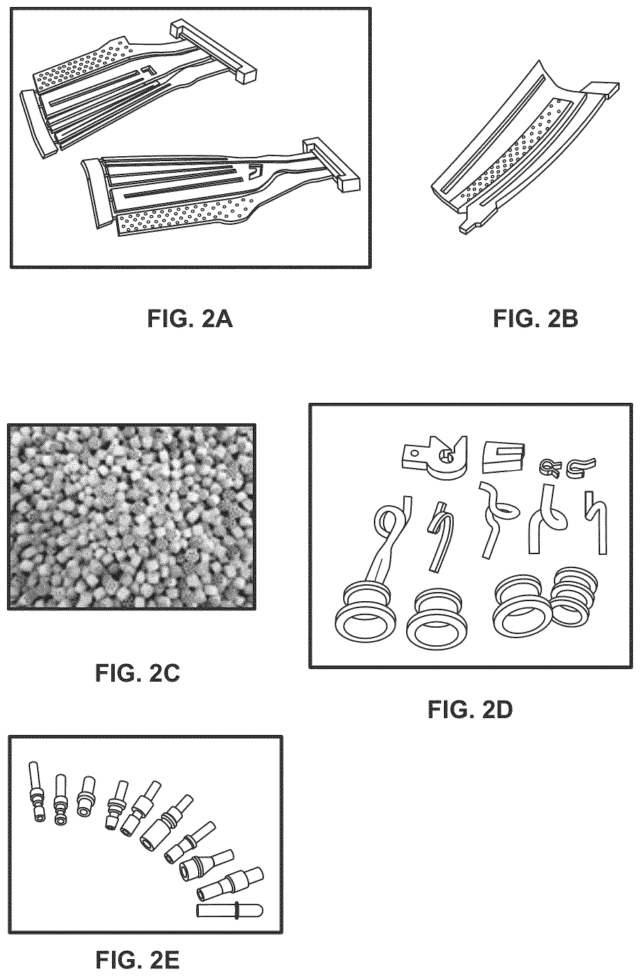

It is to be appreciated, the ceramic object may be formed in the shape that may be similar to the shape of the green body. A particular example of the ceramic object may include ceramic cores for aerospace applications, filters, catalyst supports, igniters, thread guides, bushings, or any combination thereof. Referring to FIGS. 2A-2E, exemplary ceramic objects that can be made using the compositions described in embodiments herein are illustrated, including, but not limited to, ceramic cores for investment casting of turbine components (FIGS. 2A-2B), ceramic filters and/or catalyst supports (FIG. 2C), ceramic bushings and threaded guides (FIG. 2D), and ceramic igniters (FIG. 2E).

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. A composition, comprising:
a ceramic material in a content of greater than 50 vol % for a total volume of the composition; and
a binder system comprising a first organic material that is water soluble and a second organic material comprising a melting temperature below 100° C., wherein the second organic material is water insoluble.

Embodiment 2. The composition of embodiment 1, wherein the second organic material comprises a melt flow rate of at most 22 g/10 min, at most 20 g/10 min, at most 18 g/10 min, at most 17 g/10 min, at most 16 g/10 min, at most 15 g/10 min, at most 14 g/10 min, at most 13 g/10 min, at most 12 g/10 min, or at most 11 g/10 min; and/or wherein the second organic material comprises a melt flow rate of at least 3 g/10 min, at least 5 g/10 min, at least 6 g/10 min, at least 7 g/10 min, at least 8 g/10 min, at least 9 g/10 min, at least 10 g/10 min, or at least 11 g/10 min.

Embodiment 3. The composition of embodiment 1 or 2, wherein the second organic material comprises a viscosity of at most 500 Pas at a shear rate of 100 [l/s]; and/or wherein the second organic material comprises a viscosity of at most 5000 Pas at a shear rate of 0.1 [l/s].

Embodiment 4. The composition of any one of embodiments 1 to 3, wherein the binder system comprises the first organic material of greater than 50 wt % of a total weight of the binder system, at least 54 wt %, at least 58 wt %, at least 61 wt %, at least 64 wt %, at least 67 wt %, at least 70 wt %, at least 72 wt %, or at least 74 wt % of the total weight of the binder composition; and/or at most 91 wt % of the total weight of the binder system, at most 88 wt %, at most 85 wt %, at most 82 wt %, at most 80 wt %, at most 77 wt %, at most 75 wt %, or at most 73 wt % of the total weight of the binder system.

Embodiment 5. The composition of any one of embodiments 1 to 4, wherein the binder system comprises the second organic material of at least 5 wt % of a total weight of the binder system, at least 8 wt %, at least 10 wt %, at least 12 wt %, at least 13 wt %, at least 15 wt %, at least 17 wt %, or at least 19 wt % of the total weight of the binder system; and/or less than 50 wt % of the total weight of the binder system, at most 45 wt %, at most 42 wt %, at most 38 wt %, at most 34 wt %, at most 31 wt %, at most 28 wt %, at most 25 wt %, at most 22 wt %, at most 20 wt %, at most 18 wt %, or at most 16 wt % of the total weight of the binder system.

Embodiment 6. The composition of any one of embodiments 1 to 5, wherein the melting temperature of the second organic material is at most 97° C., at most 95° C., at most 92° C., at most 90° C., at most 87° C., at most 85° C., at most 83° C., at most 81° C., at most 78° C., at most 75° C., at most 72° C., at most 69° C., at most 66° C., at most 64° C., at most 62° C., or at most 60° C.; and/or wherein the melting temperature of the second organic material is at least 40° C., at least 44° C., at least 47° C., at least 50° C., at least 53° C., at least 55° C., at least 58° C., at least 60° C., at least 62° C., at least 64° C., at least 67° C., at least 70° C., at least 72° C., or at least 75° C.

Embodiment 7. The composition of any one of embodiments 1 to 6, wherein the first organic material has a solubility in water at 20° C. to 25° C. of at least 30%, at least 40%, at least 50%, at least 60%, at least 80%, or at least 98%; and/or wherein the solubility of the first organic material in water at 20° C. to 25° C. is 100% or less, at most 98%, at most 90%, at most 80%, at most 70%, or at most 60%, or at most 50%.

Embodiment 8. The composition of any one of embodiments 1 to 7, wherein the first organic material comprises a melting temperature below 100° C., at most 92° C., at most 85° C., at most 73° C., at most 60° C., at most 55° C., at most 50° C., at most 47° C., at most 44° C., at most 40° C., or at most 38° C.; and/or wherein the first organic material comprises a melting temperature of at least 27° C., at least 30° C., at least 33° C., at least 35° C., at least 37° C., at least 40° C., at least 44° C., at least 48° C., at least 52° C., or at least 55° C.

Embodiment 9. The composition of any one of embodiments 1 to 8, wherein the first organic material comprises a melt flow rate of at least 10 g/10 min, at least 30 g/10 min, at least 50 g/10 min, at least 80 g/10 min, at least 100 g/10 min, at least 130 g/10 min, at least 150 g/10 min, at least 180 g/10 min, at least 200 g/10 min, or at least 300 g/10 min; and/or wherein the melt flow rate of the first organic material is at most 1000 g/10 min, at most 800 g/10 min, at most 600 g/10 min, at most 500 g/10 min, at most 400 g/10 min, at most 300 g/10 min, at most 200 g/10 min, at most 100 g/10 min, or at most 50 g/10 min.

Embodiment 10. The composition of any one of embodiments 1 to 9, wherein the first organic material comprises polyethylene glycol having a molecular weight of greater than 800 g/mol or at least 1000 g/mol; and/or wherein the molecular weight of polyethylene glycol is at most 4000 g/mol, at most 3350 g/mol, at most 2000 g/mol, or at most 1000 g/mol.

Embodiment 11. The composition of any one of embodiments 1 to 10, wherein the second organic material comprises ethylene-vinyl acetate copolymer, polycaprolactone, ethylene butyl acrylate copolymer, or any combination thereof.

Embodiment 12. The composition of any one of embodiments 1 to 11, wherein a total content of the binder system is at least 9 vol % of the composition, at least 11 vol %, at least 15 vol %, at least 18 vol %, at least 20 vol %, at least 23 vol %, at least 25 vol %, at least 28 vol %, at least 31 vol %, at least 34 vol %, or at least 38 vol % of the composition; and/or wherein total content of the binder composition is at most 49 vol % of the composition, at most 45 vol %, at most 40 vol %, at most 35 vol %, at most 33 vol %, at most 30 vol %, at most 28 vol %, or at most 25 vol %.

Embodiment 13. The composition of any one of embodiments 1 to 12, wherein the content of the ceramic material is at least 52 vol % for the total volume of the composition, at least 55 vol %, at least 58 vol %, at least 60 vol %, at least 62 vol %, at least 63 vol %, or at least 65 vol % for the total volume of the composition; and/or wherein the content of the ceramic material is at most 85 vol % for the total volume of the composition, at most 82 vol %, at most 80 vol %, at most 78 vol %, at most 76 vol %, at most 75 vol %, at most 72 vol %, at most 70 vol %, at most 68 vol %, at most 66 vol %, at most 65 vol %, or at most 64 vol % for the total volume of the composition.

Embodiment 14. The composition of any one of embodiments 1 to 13, wherein the ceramic material comprises an oxide, a carbide, a nitride, diamond, or a combination thereof.

Embodiment 15. The composition of any one of embodiments 1 to 14, wherein the ceramic material comprises an oxide, wherein the oxide comprises one or more of metal oxides comprising aluminum oxide; chromium oxide; silicon oxide; one or more of alkaline earth metal oxide including magnesium oxide, calcium oxide, barium oxide, strontium oxide, or any combination thereof; one or more of alkali metal oxide including lithium oxide; a rare earth oxide including yttrium oxide, zirconium oxide, or any combination thereof; or any combination thereof.

Embodiment 16. The composition of any one of embodiments 1 to 15, wherein the ceramic material comprises a primary component comprising first particles having a first median particle size greater than 12 microns and at most 72 microns, at least 20 microns and at most 60 microns, at least 30 microns and at most 300 microns, at most 200 microns, at most 100 microns, at most 90 microns, at most 80 microns, at most 70 microns, at most 55 microns, or at least 40 microns and at most 50 microns.

Embodiment 17. The composition of embodiment 16, wherein a content of the first particles is at least 35 wt % and at most 75 wt % of the primary component, at least 40 wt % and at most 60 wt %, at least 45 wt % and at most 55 wt % of the primary component.

Embodiment 18. The composition of any one of embodiments 16 to 17, wherein the primary component comprises second particles having a second median particle size of at least 2 microns and at most 12 microns, at least 4 microns and at most 10 microns, or at least 6 microns and at most 8 microns.

Embodiment 19. The composition of embodiment 18, wherein a content of the second particles is at least 5 wt % and at most 46 wt % of the primary component, at least 12 wt % and at most 42 wt %, or at least 22 wt % and at most 32 wt % of the primary component.

Embodiment 20. The composition of any one of embodiments 16 to 19, wherein the primary component comprises third particles having a third median particle size of at least 0.1 microns and less than 2 microns, at least 0.15 microns and at most 1.2 microns, or at least 0.2 microns and at most 0.7 microns.

Embodiment 21. The composition of embodiment 20, wherein a content of the third particles is at least 3 wt % and at most 44 wt % of the primary component, at least 8 wt % and at most 38 wt %, or at least 15 wt % and at most 28 wt % of the primary component.

Embodiment 22. The composition of any one of embodiments 16 to 21, wherein a content of the primary component is at least 75 wt % for the total weight of the ceramic material, at least 77 wt %, at least 79 wt %, at least 81 wt %, at least 83 wt %, at least 85 wt %, at least 87 wt %, or at least 89 wt % for the total weight of the ceramic material; and/or wherein the content of the primary component is at most 98 wt % of the ceramic material, at most 95 wt %, at most 93 wt %, at most 91 wt %, at most 89 wt %, or at most 87 wt % of the ceramic material.

Embodiment 23. The composition of any one of embodiments 16 to 22, wherein the primary component comprises aluminum oxide, silicon carbide, zirconium oxide, zircon, chromium oxide, or a combination thereof.

Embodiment 24. The composition of any one of embodiments 1 to 23, wherein the ceramic material comprises one or more metal oxides comprise aluminum oxide, lithium oxide, strontium oxide, yttrium oxide, and magnesium oxide.

Embodiment 25. The composition of any one of embodiments 1 to 24, further comprising a coupling agent.

Embodiment 26. The composition of any one of embodiments 1 to 25, comprising a viscosity of at least 0.01 to 1000 Pas at the shear rate from 1 to 100 (1/s) at 70° C. to 80° C.

### EXAMPLES

### Example 1

Sample S1 is prepared having the composition below. Sample S1 includes 65 vol % of a ceramic material and 35 vol % of a binder system for a total volume of the composition of S1. The ceramic material includes 72 wt % to 78 wt % of aluminum oxide, 5 wt % to 8 wt % of yttrium oxide, and 1 to 2 wt % of magnesium oxide for the total weight of the ceramic material. It is to be appreciated that the contents of the oxides add up to 100 wt % even though ranges are provided. The binder system includes 70-73 wt % of PEG-1000 and the remainder of Capa 6250.

Sample S2 is prepared having the same composition as Sample S1 except that Capa 6250 is replaced with ethylene-vinyl acetate (EVA). Samples S1 and S2 have the MFI of approximately 30 g/10 min at 90° C. measured as described in embodiments herein.

Capa 6250 has a melt flow index of 7-11 g/10 min at 90° C. measured as described in embodiments herein and melting point of 58° C. to 60° C.

EVA has a melt flow index of 10 g/10 min measured at 90° C. and melting point of 58-60° C.

PEG-1000 and Capa 6250 are compatible. Phase separation is not observed for the mixture of PEG-1000 and Capa 6250. Similarly, PEG-1000 and EVA are compatible, as phase separation is not observed for the mixture of PEG-1000 and EVA.

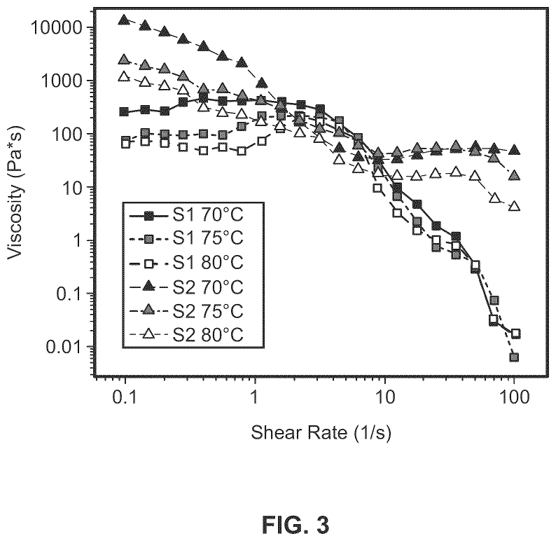

Viscosity of Samples S1 and S2 are measured at temperatures of 70° C., 75° C., and 80° C. using Anton Parr Rheometer at shear rates from 0.1 to 100 [l/s]. Viscosity of the samples is illustrated in FIG. 3. Both samples demonstrate decreased viscosity with increased shear rates.

Sample S1 has a viscosity of approximately 60 Pas at the shear rate of 0.1 [l/s] and at 75° C. and 80° C. and a viscosity of approximately 115 Pas at the shear rate of 0.1 [l/s] and at 70° C. Sample S2 has a viscosity at the shear rate of 0.1 [l/s] of approximately 1000 Pa*s, 1150 Pa*s, and 10500 Pa*s at 80° C., 75° C., and 70° C., respectively.

Sample S1 has a viscosity at the shear rate of 100 [l/s] of approximately 0.002 to 0.003 Pa*s at 70° C. and 75° C. and 0.02 Pa*s at 80° C.

Sample S2 has a viscosity at the shear rate of 100 [l/s] of approximately 4 Pa*s, 20 Pa*s, and 100 Pa*s at 80° C., 75° C., and 70° C., respectively.

The compositions of Samples S1 and S2 are formed into bars as described in embodiments herein. In brief, the compositions of S1 and S2 are compounded at 90° C. and 100 rpm, and injection molding are performed at 75° C. and at 5 bar to form the green bodies including the compositions of S1 and S2, respectively. The green bodies are immersed in water at room temperature for 6 to 8 hours to remove PEG-1000 and heated at 450° C. for 4 hours to remove Capa 6250 and EVA, respectively. The green bodies are then sintered at 1800° C. for 60 hours to form the ceramic bars. Acceptable thickness shrinkage of 0.94% and diameter shrinkage of 2.78% is observed for bars formed using the compositions of Samples S1 and S2.

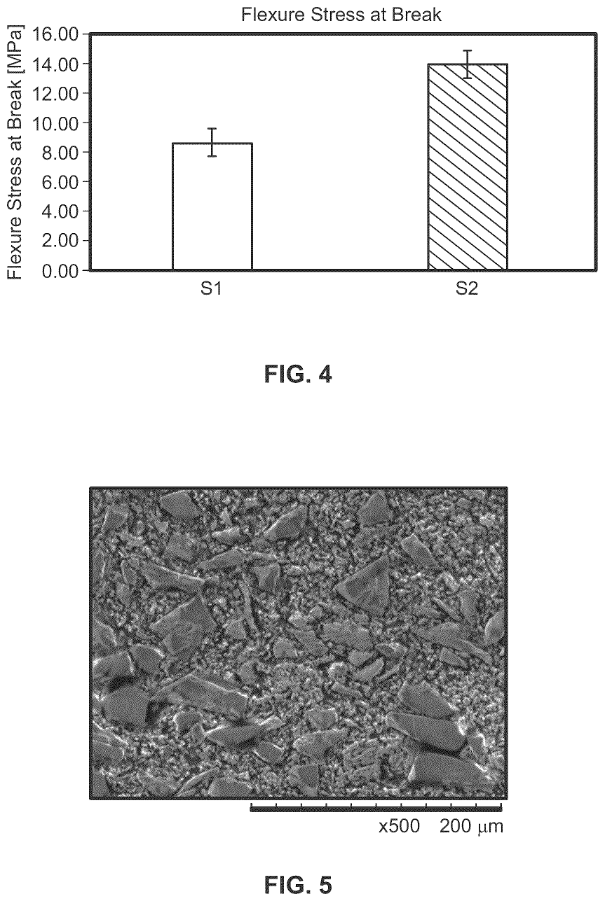

A 4-point bend test is performed to determine fix flexure stress at break of the bar samples using Instron with 20×40 mm Wyoming fixture and 1 KN load. The results are illustrated in FIG. 4. The bar samples formed using the compositions of Samples S1 and S2 have sufficient strength, 8.5 MPa and 14 MPa, respectively, for the intended application.

FIG. 5 includes an SEM image of the microstructure of a portion of a bar sample made using the composition of Sample S1. It can be observed that the sample has a uniform microstructure.

### Example 2

Sample S3 is prepared including the same ceramic material as Sample S1. The binder system of Sample S3 includes PEG-1000 and polyhydroxyalkanoate (PHA). The Sample S3 includes 65 vol % to 75 vol % of the ceramic material and the remainder of the binder system for a total volume of the composition of S3. The binder system includes 70-80 wt % of PEG-1000 and the remainder of PHA.

Sample S4 is prepared including the same ceramic material as Sample S1. The binder system of Sample S3 includes PEG-1000 and EBA. The Sample S4 includes 65 vol % to 75 vol % of the ceramic material and the remainder of the binder system for a total volume of the composition of S4. The binder system includes 70-80 wt % of PEG-1000 and the remainder of EBA.

PHA has a melting temperature of 95° C. EBA has a melting temperature of 40° C. The melt flow index of PHA and EBA will be tested. Viscosity of Samples S3 and S4 will be tested at the shear rates from 0.1 to 100 [l/s] at the temperatures including 65° C., 70° C., 75° C., and 80° C., respectively and are expected to have shear thinning behavior, reduced viscosity at increased shear rates.

### Example 3

Sample S5 is prepared including the same ceramic material and binder system as Sample S1 except the composition includes 69 vol % of the ceramic material and 31 vol % of the binder system. Viscosity of Sample S5 is tested at the shear rates from 0.1 to 100 [l/s] at the temperatures including 65° C., 70° C., 75° C., and 80° C., respectively. Similar to Sample S1, S5 demonstrates decreased viscosity with increased shear rates at each tested temperature.

### Example 4

Feedstock samples are prepared having the formulations noted in Table 1 below. Capa 6250 has the approximate molecular weight of 25,000 g/mol and Capa 6500 has the approximate molecular weight of 50,000 g/mol.

TABLE 1

| Formulation | Feed- | Feed- | Feed- | Feed- |
|---|---|---|---|---|
| (vol %) | stock 1 | stock 3 | stock 4 | stock 2 |
| Alumina (Al2O3) | 68.4% | 64.7% | 64.6% | 64.7% |
| Magnesium | / | / | / | / |
| Oxide (MgO) | | | | |
| Yttrium | / | / | / | / |
| Oxide (Y2O3) | | | | |
| PEG 1K | 19.0% | 21.8% | 21.7% | / |
| PEG 8K | / | / | / | 21.8% |
| CAPA 6250 | 9.0% | / | 10.3% | 10.3% |
| CAPA 6500 | / | 10.3% | / | / |
| Glycol Stearate | 3.5% | 3.2% | 3.4% | 3.2% |
| Total | 100.0% | 100.0% | 100.0% | 100.0% |

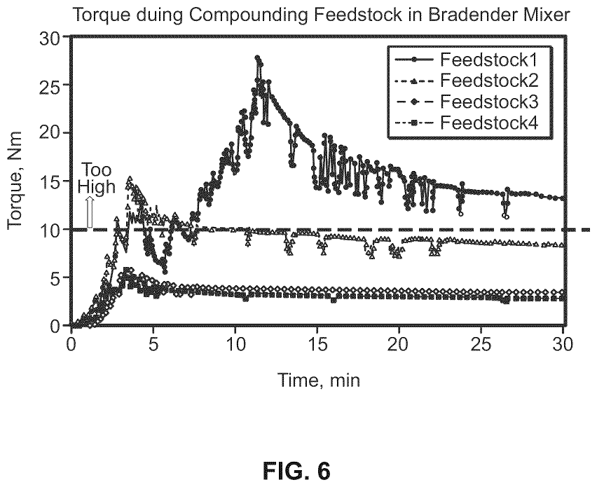

Flowability of the feedstock samples at a temperature below 100° C. was evaluated by measuring Torque Values during compounding of the feedstock samples in a Brabender Mixer. A relatively Torque Value may indicate a relatively higher flowability, which indicates a relatively higher low pressure injection ability. Compounding of the samples is conducted with the temperature set at 90° C. and the blade rotation speed 60 rpm. The mixing time is 30 min. If the final Torque Value, which is the value at the end of the mixing, of the feedstock is higher than 10 Nm, the feedstock is not suitable for injection molding at a temperature below 100° C. and pressure below 100 psi, which are referred to as low temperature and low pressure for injection molding. In FIG. 6, the Torque Values of the samples over the 30-minute mixing time are illustrated. The final Torque Values of Feedstock 1 is approximately 13 Nm. The final Torque Value of Feedstock 3 reached approximately 8. The final Torque Values of Feedstock 4 and Feedstock 5 are about 3.5 Nm and 3.1 Nm, respectively. Feedstock samples 1 may not be suitable for low-temperature and low-pressure injection molding due to poor flowability under low temperature and pressure. Feedstock sample 2 is expected to be moldable in conditions of low temperature and pressure. Feedstock samples 3 and 4 appear most desirable for low-temperature and low-pressure injection molding process.

### Example 5

Compatibility of binders is tested. Binders are mixed at a weight ratio of 50:50 using a High Throughput System at 90° C. for 10 min, injected into a disk mold (40 mm in diameter×2 mm in height) and then allowed to cool down. If the mixture remains uniform, the mixed binders are considered compatible. If phase separation is observed, the binders are considered not compatible.

PEG 1000 is mixed with prime low density polyethylene sourced from ChasePlastics® as described above. Phase separation is visible in the mixture after cooling down. PEG 1000 and low density polyethylene may not be considered compatible.

The foregoing embodiments represent a departure from the state-of-the-art. Embodiments are directed to a composition including a ceramic material and a binder system. In particular, the composition can have improved properties including one or more of final Torque Value, flowability, solid loading, and viscosity and can allow improved formation of a green body having any desired shape and improved formation of a ceramic object having a finally formed body in a shape similar to the green body. Furthermore, the composition of embodiments herein can allow formation of ceramic objects at a lower temperature and/or at a lower pressure, which may be particularly suited for forming objects having complex shapes, e.g., ceramic cores, for which dies made with plastic materials may be desired for reduced production time and cost.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Reference herein to a material including one or more components may be interpreted to include at least one embodiment wherein the material consists essentially of the one or more components identified. The term “consisting essentially” will be interpreted to include a composition including those materials identified and excluding all other materials except in minority contents (e.g., impurity contents), which do not significantly alter the properties of the material. Additionally, or in the alternative, in certain non-limiting embodiments, any of the compositions identified herein may be essentially free of materials that are not expressly disclosed. The embodiments herein include a range of contents for certain components within a material, and it will be appreciated that the contents of the components within a given material total 100%.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A composition, comprising:
a ceramic material in a content of greater than 50 vol % for a total volume of the composition; and
a binder system comprising a first organic material that is water soluble and a second organic material comprising a melting temperature below 100° C., wherein the second organic material is water insoluble.

2. The composition of claim 1, wherein the second organic material comprises a melt flow rate of at most 22 g/10 min.

3. The composition of claim 1, wherein the second organic material comprises a viscosity of at most 500 Pas at a shear rate of 100 [l/s]; and/or a viscosity of at most 5000 Pas at a shear rate of 0.1 [l/s].

4. The composition of claim 1, wherein the binder system comprises greater than 50 wt % and at most 85 wt % of the first organic material of a total weight of the binder system.

5. The composition of claim 1, wherein the binder system comprises at least 5 wt % and at most 42 wt % of the second organic material of a total weight of the binder system.

6. The composition of claim 1, wherein the first organic material comprises a melting temperature below 100° C.

7. The composition of claim 1, wherein the first organic material comprises a melt flow rate of at least 10 g/10 min and at most 1000 g/10 min.

8. The composition of claim 1, wherein the first organic material comprises polyethylene glycol having a molecular weight of greater than 800 g/mol and at most 8000 g/mol.

9. The composition of claim 1, wherein the second organic material comprises ethylene-vinyl acetate copolymer, polycaprolactone, ethylene butyl acrylate copolymer, or any combination thereof.

10. The composition of claim 1, wherein a total content of the binder system is at least 15 vol % and at most 40 vol % for a total value of the composition.

11. The composition of claim 1, wherein the content of the ceramic material is at least 56 vol % and at most 68 vol % for the total volume of the composition.

12. The composition of claim 1, wherein the ceramic material comprises an oxide, a carbide, a nitride, diamond, or a combination thereof.

13. The composition of claim 1, wherein the ceramic material comprises aluminum oxide; chromium oxide, silicon oxide; magnesium oxide, strontium oxide, lithium oxide, yttrium oxide, zirconium oxide, or any combination thereof.

14. The composition of claim 1, wherein the ceramic material comprises a primary component comprising first particles having a first median particle size greater than 12 microns and at most 300 microns.

15. The composition of claim 14, wherein a content of the first particles is at least 35 wt % and at most 75 wt % of the primary component.

16. The composition of claim 15, wherein the primary component comprises second particles having a second median particle size of at least 2 microns and at most 12 microns.

17. The composition of claim 16, wherein a content of the second particles is at least 5 wt % and at most 32 wt % of the primary component.

18. The composition of claim 17, wherein the primary component comprises third particles having a third median particle size of at least 0.1 microns and less than 2 microns.

19. The composition of claim 18, wherein a content of the third particles is at least 3 wt % and at most 28 wt % of the primary component.

20. The composition of claim 1, comprising a final Torque Value of not greater than 10 Nm and/or a viscosity of at least 0.01 to 1000 Pas at the shear rate from 1 to 100 (1/s) at 70° C. to 80° C.
